(19) United States
(12) Patent Application Publication
(10) Pub. No.: US 2011/0007019 A1
(43) Pub. Date: Jan. 13, 2011

(54) SYSTEMS AND METHODS FOR USING TFT-BASED LCD PANELS AS CAPACITIVE TOUCH SENSORS

(75) Inventor: Nir TASHER, Tel Mond (IL)

Correspondence Address: OLIFF & BERRIDGE, PLC, P.O. BOX 320850, ALEXANDRIA, VA, 22320-4850, US

(73) Assignee: NUVOTON TECHNOLOGY CORPORATION, Taiwan (CN)

(21) Appl. No.: 12/498,711

(22) Filed: Jul. 7, 2009

(51) Int. Cl. G06F 3/044

(52) U.S. Cl. 345/174

(57) ABSTRACT

A display screen system operative in the presence of backlight, which may be provided by a rear light source or by a mirror according to reflective LCD technologies, to identify presence of a conductive member such as a finger, the system comprising a structural, transparent planar element including an array of structural, planar conductive areas independently electrically addressable by a source of electric power, each conductive area having a plurality of transparency states controlled by said source of electric power; and capacitance sensing circuitry operative to sense capacitance of at least one of said conductive areas.

### REFERENCE TO CO-PENDING APPLICATIONS

U.S. patent application Ser. No. 11/889,435 entitled “Time interval measurement for capacitive detection” and filed 13 Aug. 2007 is co-pending.

### FIELD OF THE INVENTION

The present invention relates generally to capacitive touch sensors and more particularly to capacitive touch sensors used in conjunction with TFT-based LCD panels.

### BACKGROUND OF THE INVENTION

According to Wikipedia, a touchscreen is a display that can detect the presence and location of a touch within the display area. The term generally refers to touch or contact to the display of the device e.g. by a finger. A capacitive touchscreen panel is a sensor typically made of glass coated with a transparent conductor such as indium tin oxide (ITO). This type of sensor is basically a capacitor in which the plates are the overlapping areas between the horizontal and vertical axes in a grid pattern. Since the human body also conducts electricity, a touch on the surface of the sensor will affect the electric field and create a measurable change in the capacitance of the device. These sensors work on proximity, and do not have to be directly touched to be triggered. It is a durable technology that is used in a wide range of applications including point-of-sale systems, industrial controls, and public information kiosks.

A capacitive touch sensor, then, detects the touch or proximity of a human finger to its surface. The detection is performed by measuring the capacitance between the panel, or an element in the panel surface, to a virtual ground. This method has been used for many years in capacitive keys and capacitive touch pads.

Still according to Wikipedia, “[a] thin film transistor liquid crystal display (TFT-LCD) is a variant of liquid crystal display (LCD) which uses thin film transistor (TFT) technology to improve image quality (e.g. addressability, contrast). TFT LCD is one type of active matrix LCD, though all LCD-screens are based on TFT active matrix addressing. TFT LCDs are used in television sets, computer monitors, mobile phones and computers, handheld video game systems, personal digital assistants, navigation systems, projectors, etc.

“Small liquid crystal displays as used in calculators and other devices have direct driven image elements—a voltage can be applied across one segment without interfering with other segments of the display. This is impractical for a large display with a large number of picture elements (pixels), since it would require millions of connections—top and bottom connections for each one of the three colors (red, green and blue) of every pixel. To avoid this issue, the pixels are addressed in rows and columns which reduce the connection count from millions to thousands. If all the pixels in one row are driven with a positive voltage and all the pixels in one column are driven with a negative voltage, then the pixel at the intersection has the largest applied voltage and is switched. The problem with this solution is that all the pixels in the same column see a fraction of the applied voltage as do all the pixels in the same row, so although they are not switched completely, they do tend to darken. The solution to the problem is to supply each pixel with its own transistor switch which allows each pixel to be individually controlled. The low leakage current of the transistor prevents the voltage applied to the pixel from leaking away between refreshes to the display image. Each pixel is a small capacitor with a layer of insulating liquid crystal sandwiched between transparent conductive ITO layers.

“The circuit layout of a TFT-LCD is very similar to that of a DRAM memory. However, rather than fabricating the transistors from silicon formed into a crystalline wafer, they are made from a thin film of silicon deposited on a glass panel. Transistors take up only a small fraction of the area of each pixel; the rest of the silicon film is etched away to allow light to pass through.

Published US Application No. 2009/0079707 A1 to Kaehler (assigned to Motorola), 2009/0135158 A1 to Takahashi et al and 2008/0062140 A1 assigned to Apple and entitled “Touch screen liquid crystal display” describe various display screens and associated methods for sensing an object such as a finger, near the surfaces thereof.

A conventional TFT LCD display, as shown in prior art FIG. 1B, includes rows and columns of conductors deposited on transparent surfaces. On each intersection of row and column conductor, a silicon FET transistor is manufactured using Thin Film Technology (TFT). The gate of the FET is driven by the column wire, while the source is connected to the row wire. The drain of each FET is connected to a pixel element made of a transparent conductor (mostly ITO—Indium Tin Oxide) that acts as one electrode of the LCD display. When both row and column of a specific pixel are energized, the pixel brightness level may be adjusted. Standard LCD scan process energizes a single column, enabling all the FETs of that column, and then drives appropriate voltages to all the row lines. Only the pixels of the energized column are changed while other columns remain unchanged since the other FETs are in OFF state. In a color LCD display, there are R for red, G for green and B for blue elements, termed “subpixels”, per pixel. Each subpixel is therefore an R, G or B spatial component of the total area of the corresponding pixel.

The disclosures of all publications and patent documents mentioned in the specification, and of the publications and patent documents cited therein directly or indirectly, are hereby incorporated by reference.

### SUMMARY OF THE INVENTION

Certain embodiments of the present invention seek to provide apparatus and methods for using the electrodes of the LCD as capacitive touch and proximity sensor elements. By energizing a single column or a group of adjacent columns, the electrodes associated with the columns are shorted to the row signals. The row signals can then be used to measure the capacitance sensed by the electrodes. The capacitance sensed is a factor of the electrode size, distance from backplane, LCD material and the presence of a conductive element adjacent to the electrode.

When the normal operation capacitance is measured and used to calibrate the sensing logic, a change in the capacitance caused by the proximity of a finger may be detected. The entire array or any part of it may be scanned, either column by column or by groups of columns. Adjacent rows may also be shorted together to minimize the total number of scanned rows.

One way of measuring capacitance is to charge the rows from one preset voltage to another preset voltage, with known, constant current. The charge time between the two voltages is proportional to the capacitance. Other measurement methods exist such as measuring the resulting voltage of the sensor after a predetermined charge time has elapsed. A conventional formula for charging a capacitance is:

$$Δ V = \frac{1}{C} \int I δ t$$

where C is the capacitance, I is the charge current, dt is the elapsed time and ΔV represents the change in voltage. The capacitance scan can be effected during the so called “dead time” of the display—horizontal and vertical blank periods, for example. It can also be interleaved with a regular LCD scan process. Measurements can even be taken during the actual LCD drive by using known current and measuring pixel set times.

The illumination/transparency state of the LCD pixel may also affect the electrode capacitance. The pixel state information, available as part of the frame buffer information can be used to compensate for the electrode capacitance during the processing stage. The capacitance measurement method shown herein can be used with any TFT or TFT-like active matrix array. Such a matrix may be used with devices such as but not limited to LCDs, OLED, and electro-phoretic displays.

The methods and systems described herein can also be employed in applications where the TFT is solely used to detect capacitance and not as part of a display element.

Particular advantages of certain embodiments of the present invention shown and described herein may include one, some or all of the following: (a) the source line of the display panel is used for sensing capacitance; no separate capacitance sensing line need be provided; (b) the display panel pixel is used as a touch sensor; no separate sensor need be provided; and (c) only one TFT switch suffices for implementation.

There is thus provided, in accordance with at least one embodiment of the present invention, a display screen system operative, in the presence of backlight, to identify presence of a conductive member such as a display screen user's finger, the system comprising a structural, transparent planar element including an array of conductive areas independently electrically addressable by a source of electric power, each conductive area having a plurality of transparency states controlled by the source of electric power; and capacitance sensing circuitry operative to sense capacitance of at least one of the conductive areas.

Further in accordance with at least one embodiment of the present invention, the plurality of transparency states includes a plurality of states differing in their degree of transparency to light of at least one wavelength.

Additionally in accordance with at least one embodiment of the present invention, at least one of the areas comprises a sub-pixel.

Still further in accordance with at least one embodiment of the present invention, the capacitance sensing circuitry is operative to separately sense capacitance in each of the conductive areas.

Additionally in accordance with at least one embodiment of the present invention, the system also comprises a conductive member identifier operative to analyze capacitance sensed by the circuitry in an individual conductive area and to generate a binary output indicating presence or absence of a conductive member adjacent the individual conductive area.

Also provided, in accordance with at least one embodiment of the present invention, is a method for providing a display screen system operative, in the presence of backlight, to identify presence of a conductive member such as a finger, the method comprising providing a TFT-based display glass substrate including source lines; and providing apparatus for controlling transparency of portions of the substrate and capacitance sensing circuitry operative to sense capacitance of at least a portion of the substrate, including using the source lines for sensing capacitance.

Further in accordance with at least one embodiment of the present invention, the method also comprises using timing controller apparatus to temporally control the apparatus for controlling transparency.

Still further in accordance with at least one embodiment of the present invention, the substrate comprises a TFT-LCD glass substrate.

Also in accordance with at least one embodiment of the present invention, the method also comprises providing a source driver including the apparatus for controlling transparency.

Further in accordance with at least one embodiment of the present invention, the source driver also includes the capacitance sensing circuitry.

Further in accordance with at least one embodiment of the present invention, the method also comprises providing a gate driver including the apparatus for controlling transparency.

Still further in accordance with at least one embodiment of the present invention, the glass substrate includes at least one gate driver.

Also provided, in accordance with at least one embodiment of the present invention, is a method for using a display screen system operative, in the presence of backlight, to identify presence of a conductive member, the method comprising providing a structural, transparent planar element including an array of conductive areas independently electrically addressable by a source of electric power, each conductive area having a plurality of transparency states controlled by the source of electric power; and capacitance sensing circuitry operative to sense capacitance of at least one of the conductive areas, wherein each structural, planar conductive area comprises a pixel having a pixel inversion period, and wherein the capacitance sensing circuitry is operative, during the pixel inversion period and in presence of backlight, to identify presence of a conductive member.

Further in accordance with at least one embodiment of the present invention, the capacitance sensing circuitry is operative only during the pixel inversion period.

Still further in accordance with at least one embodiment of the present invention, the capacitance sensing circuitry is operative only in periods of time in which the transparency states of the conductive areas are constant.

Additionally in accordance with at least one embodiment of the present invention, the planar element has a first resolution defined by the areas independently addressable and wherein the conductive areas are addressable via source drivers and gate drivers and wherein, during the periods of time, sets of source drivers are shorted together and sets of gate drivers are shorted together, thereby to generate a second resolution, used for sensing capacitance during the periods of time, wherein the second resolution is lower than the first resolution which is used for display.

Further in accordance with at least one embodiment of the present invention, the sub-pixel has a current known transparency state and also comprising a capacitance modifier operative to modify a capacitance value generated by the capacitance sensing circuitry based at least partly on the transparency state.

Still further in accordance with at least one embodiment of the present invention, the conductive area includes an ITO layer.

Additionally in accordance with at least one embodiment of the present invention, the method also comprises using the planar element as a refreshable display by interleaving capacitance sensing by the capacitance sensing circuitry with refreshing of at least some of the array of conductive areas.

Further in accordance with at least one embodiment of the present invention, the display screen comprises a TFT-based display screen.

Still further in accordance with at least one embodiment of the present invention, the TFT-based display screen comprises an LCD screen.

Additionally in accordance with at least one embodiment of the present invention, the capacitance sensing circuitry is operative to identify presence of a finger.

Further in accordance with at least one embodiment of the present invention, the substrate includes subpixels each including only one TFT switch and wherein the providing includes using a single TFT switch included in an individual sub-pixel for sensing a conductive element touching the individual sub-pixel.

Also in accordance with at least one embodiment of the present invention, the substrate includes pixels and the providing includes using the pixels as touch sensors.

Further in accordance with at least one embodiment of the present invention, the providing comprises retrofitting the controlling transparency of portions of the substrate and the capacitance sensing circuitry to the TFT-based display glass substrate, externally thereto. The following terms may be construed either in accordance with any definition thereof appearing in the prior art literature or in accordance with the specification, or as follows:

Pixel inversion: a process by which the polarity of the pixel voltage of an individual pixel or a set of pixels such as a row or column or an entire frame, is inverted.

Pixel inversion period: a period during which the pixel voltage of an individual pixel or a set of pixels such as a row or column or an entire frame, is intermediate, an initial voltage having a first polarity and a final voltage having the opposite polarity.

LCD Glass (also termed herein “TFT-LCD glass substrate”): An assembly including a transparent substrate on which, typically, ITO and TFT layers are manufactured, typically including a top transparent layer, liquid crystal material and sealing around the transparent substrate and top layers. An LCD glass may also include additional components such as polarizers, color filters, and a black matrix. The LCD glass is typically connected via flexible cables to the driver devices, timing controller, power supply and host interface to form a working LCD display unit.

Also provided is a computer program product, comprising a computer usable medium or computer readable storage medium, typically tangible, having a computer readable program code embodied therein, the computer readable program code adapted to be executed to implement any or all of the methods shown and described herein. It is appreciated that any or all of the computational steps shown and described herein may be computer-implemented. The operations in accordance with the teachings herein may be performed by a computer specially constructed for the desired purposes or by a general purpose computer specially configured for the desired purpose by a computer program stored in a computer readable storage medium.

Any suitable processor, display and input means may be used to process, display e.g. on a computer screen or other computer output device, store, and accept information such as information used by or generated by any of the methods and apparatus shown and described herein; the above processor, display and input means including computer programs, in accordance with some or all of the embodiments of the present invention. Any or all functionalities of the invention shown and described herein may be performed by a conventional personal computer processor, workstation or other programmable device or computer or electronic computing device, either general-purpose or specifically constructed, used for processing; a computer display screen and/or printer and/or speaker for displaying; machine-readable memory such as optical disks, CDROMs, magnetic-optical discs or other discs; RAMs, ROMs, EPROMs, EEPROMs, magnetic or optical or other cards, for storing, and keyboard or mouse for accepting. The term “process” as used above is intended to include any type of computation or manipulation or transformation of data represented as physical, e.g. electronic, phenomena which may occur or reside e.g. within registers and/or memories of a computer.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may wherever suitable operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

### BRIEF DESCRIPTION OF THE DRAWINGS

Certain embodiments of the present invention are illustrated in the following drawings:

FIG. 1A is a simplified semi-pictorial semi-schematic diagram of a display screen system with integral capacitance sensing functionality, which may include a structural, transparent layer such as glass, source and gate drivers, a timing controller and a backlight.

FIG. 1B is a prior art simplified schematic illustration of a TFT LCD screen.

FIG. 2 is a simplified cross-sectional illustration of the backplane of FIG. 1A showing a modification of conventional LCD TFT panels which is particularly suited for panels which are to be used as capacitive touch sensors.

FIG. 3A is a simplified schematic illustration of one of the 6 sense circuits 124 in FIG. 1A in which, in contrast to an alternative embodiment shown in FIG. 3B, pixel data (a pixel's transparency state) is not used for correction of capacitance sensing.

FIG. 3B is a simplified schematic diagram of the source driver of FIG. 1A according to a second embodiment of the present invention in which a sub-pixel has a current known transparency state which is used for correction of capacitance sensing, the source driver comprising a capacitance modifier operative to modify a capacitance value generated by the capacitance sensing circuitry based at least partly on the capacitance sensing circuitry.

FIG. 4 is a simplified schematic illustration of sense unit 340 in FIGS. 3A and 3B.

FIG. 5A is a simplified schematic illustration of one of the 6 drive circuits 122 in simplified FIG. 1A, according to a first embodiment of the present invention which does not use the screen's pixel inversion period for capacitance measurement.

FIG. 5B is a simplified schematic illustration of one of the 6 drive circuits 122 in simplified FIG. 1A, according to a second embodiment of the present invention which uses the screen's pixel inversion period for capacitance measurement.

FIG. 6 is a simplified schematic diagram of the gate driver 140 of FIG. 1A.

FIG. 7 is a simplified flowchart illustration of a method for using the system of FIG. 1A.

FIG. 8 is a simplified flowchart illustration of a method for performing the calibration step of FIG. 7; as shown, the contents of registers 220 in FIGS. 3A or 3B are copied into the baseline registers 230 and serve, during operation, as baseline values representing expected capacitance of each individual pixel in the absence of a touching finger.

FIG. 9A is a simplified flowchart illustration of a method for performing the pixel capacitance measuring step in FIG. 7.

FIG. 9B is a simplified flowchart illustration of a method for performing the column capacitance measuring step in FIG. 9A.

FIG. 10 is a simplified flowchart illustration of a method for performing the touch detection step of FIG. 7.

FIG. 11 is a simplified flowchart illustration of a method for performing the touch coordinate computation step of FIG. 7.

FIGS. 12A-12B are simplified time-lines showing two suitable timings, respectively, for the operation of the capacitance sensing method of FIG. 7 vs. the refresh operation of the apparatus of FIG. 1A, useful in conjunction with the embodiments of FIGS. 5A and 5B respectively, and characterized in that capacitance sensing is performed between consecutive screen refreshes or during the refresh cycle itself, respectively.

FIG. 13A is a prior art, voltage vs. time graph showing a Pixel Inversion process.

FIG. 13B is a graph showing pixel inversion with rise/fall time measurement, useful in understanding the operation of the embodiment of FIGS. 5B and 12B.

FIG. 14 is a simplified flowchart illustration of a method for providing a display screen system operative to identify presence of a conductive member.

FIG. 15 is a simplified semi-functional block diagram semi-schematic illustration of a capacitive detection system useful in implementing an embodiment of the present invention.

FIG. 16 is a timing diagram useful in understanding the operation of the counter of FIG. 15 while the sensor of FIG. 15 is charging, according to certain embodiments of the present invention.

FIG. 17 is a simplified schematic diagram of a modification to the source driver of FIG. 1A which is suitable for embodiments in which it is desired that the resolution of the touch sensor be lower than the display resolution, e.g. due to the relatively large size of a finger relative to pixel size.

### DETAILED DESCRIPTION OF CERTAIN EMBODIMENTS

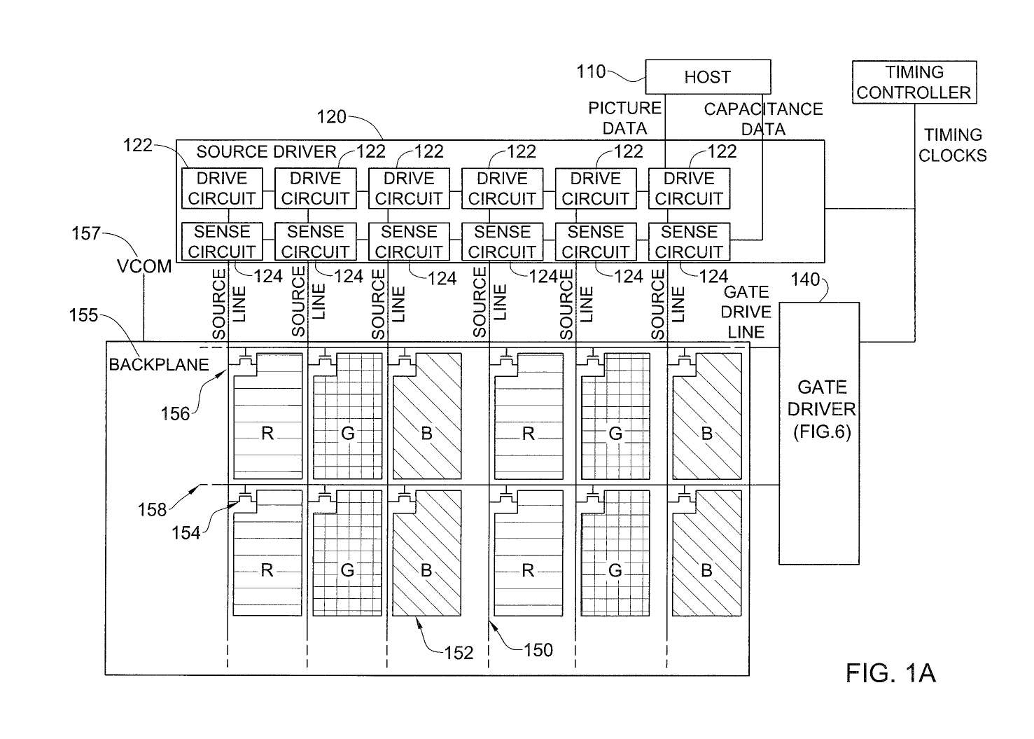

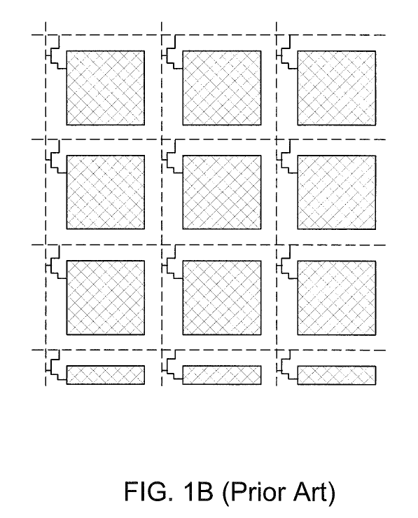

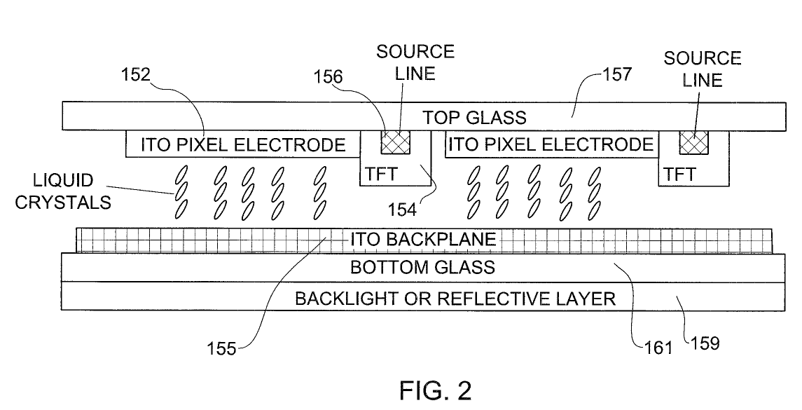

Certain embodiments of the present invention teach uses of an LCD TFT panel as a capacitive touch sensor. LCD TFT panels and methods for fabrication thereof are well known in the art. A particular advantage of certain embodiments of the present invention is that a conventional LCD panel or one modified as shown in FIGS. 1-2 may be used both to display images and simultaneously as an input device, at a cost much lower than the costs of conventional solutions. Applications may include touch screens used in portable and desktop personal computers, handheld computers, including PDAs and Smartphones, portable telephones, information kiosks, and vending machines of many kinds. To date, all these instruments use at least one touch screen that is added in front of (above or below) the LCD display. This adds to the cost of the product on the one hand, and reduces the screen brightness on the other hand, since the transparency of the added touch screen sensor is roughly 75-85%.

Moreover, the TFT panel limits the types of sensors that may be used and their placement due to both the physical and electrical qualities such as conductivity and thickness.

FIG. 1A is a simplified semi-pictorial semi-schematic diagram of a display screen system with integral capacitance sensing functionality, which may include: a structural, transparent layer such as glass; source and gate drivers 120 and 140 respectively which, via source and gate drive lines 156 and 158 respectively, operate TFT switches located at junctions defining pixels; a timing controller 130 and a backlight 159 which may optionally be provided by a mirror using conventional reflective LCD technology. The number of rows and columns may for example be 768 rows×1024 columns. VCOM is the backplane common voltage. Timing clocks may be provided by the LCD controller which is part of any commercially available LCD display.

The display screen shown is shown to include only 2×2 pixels, for simplicity, and, as is in fact usual, 3 color layers namely R, G and B resulting in 3 sub-pixels per pixel. Under this assumption, 2×3=6 drive circuits 122 and sense circuits (also termed herein “capacitance sensing circuitry”) 124 are shown. More generally, a display screen has a multiplicity of rows and columns, the numbers thereof being denoted herein as M rows×N columns.

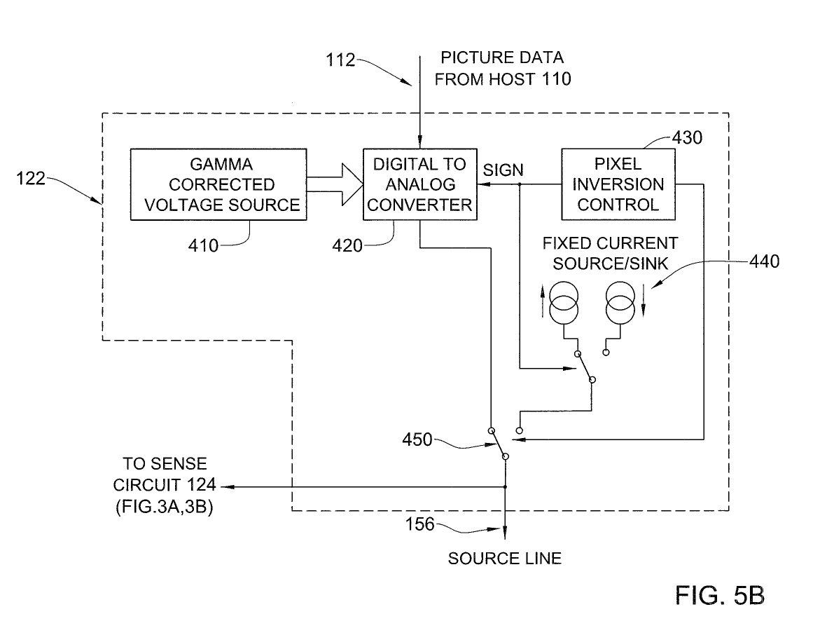

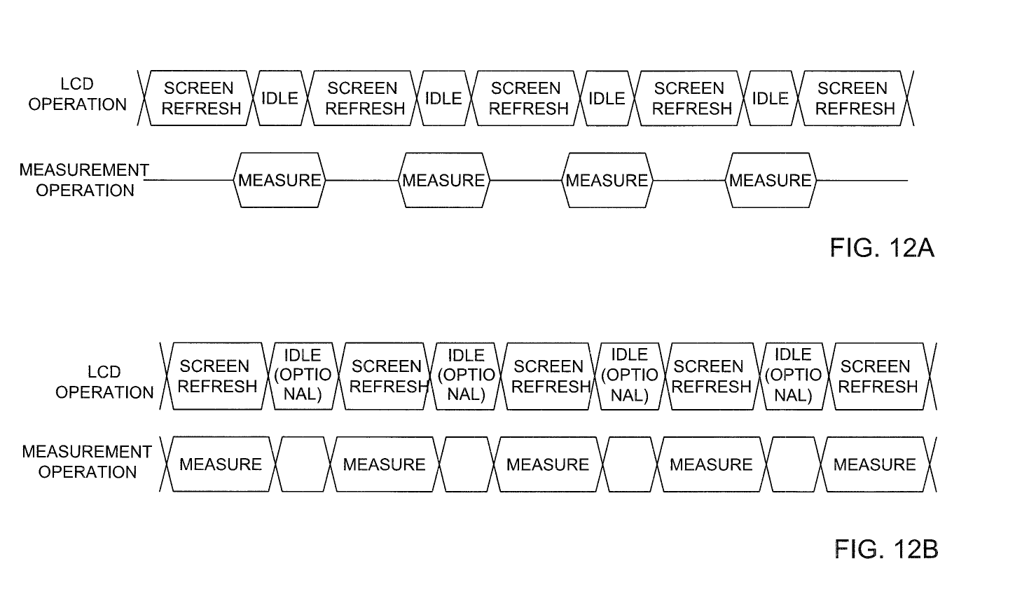

According to certain embodiments of the present invention, e.g. as shown and described herein with reference to FIGS. 5A and 12A, the gate (row) driver 140 turns on the appropriate row's FETs. The FET connects the pixel element 152 to the source (column) line 156. At this time, the pixel 152 is either driven to the required level (for display purpose) or reset and then slowly charged by the current source, while the comparators monitor the voltage rise time. The rise time is proportional to the capacitance of the pixel element 152 and changes when a conductive element such as a finger (not shown) is placed above or near a pixel 152.

The driver and detection circuits of FIG. 1A may reside in special integrated circuits. Alternatively, they may be built directly on the glass surface of the LCD e.g. using thin film technology such as LTPS (Low Temperature Poly Silicone).

FIG. 2 is a simplified cross-sectional illustration of the LCD glass of FIG. 1A showing a modification of a conventional LCD TFT panel particularly suited for panels which are to be used as capacitive touch sensors. As shown, the modification includes inverting the layer stack-up of the LCD TFT (Thin Film Transistor) panel in the event that the backplane is at the topmost conductive layer. In the inverted stack-up shown in FIG. 2, the backplane 155 is at the bottom (farther away from the touching finger) and the pixel electrodes 152 are closer to the top glass 157 hence to a user's screen-touching finger (not shown).

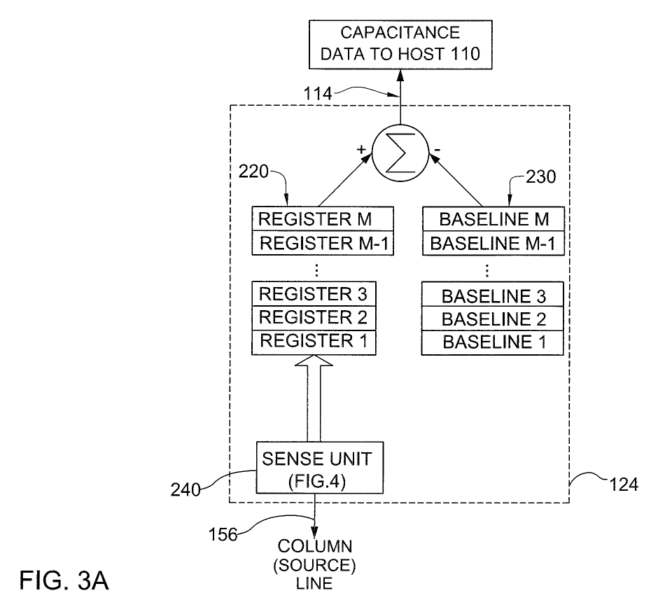

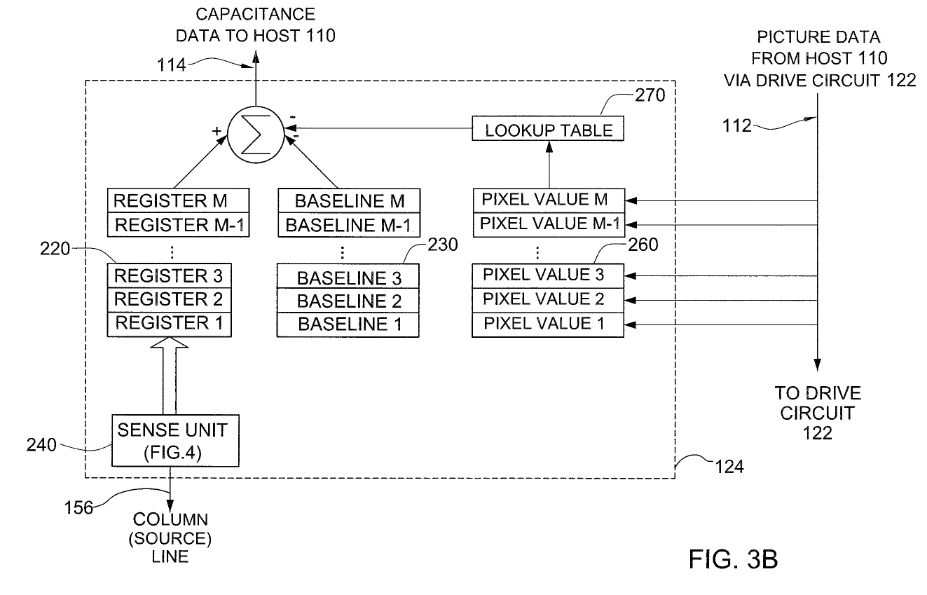

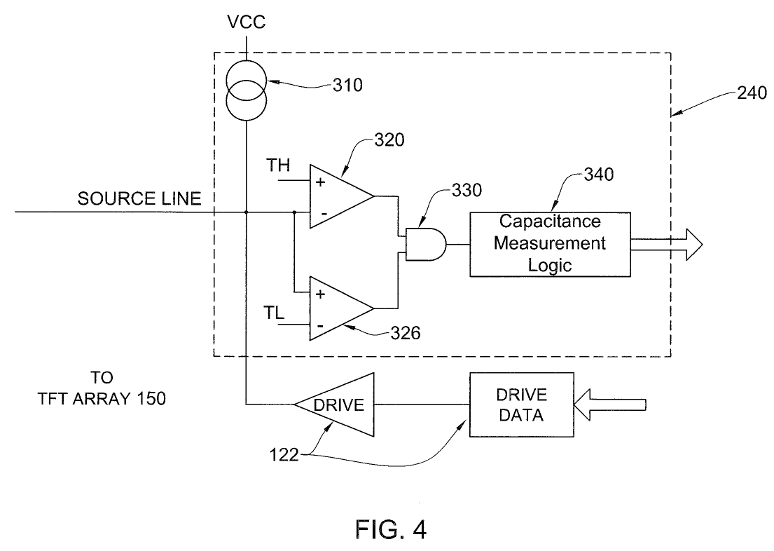

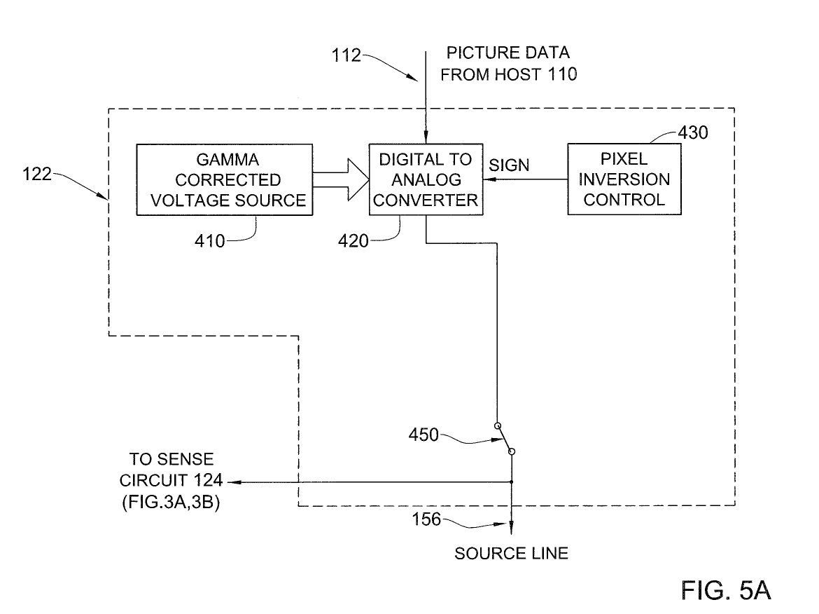

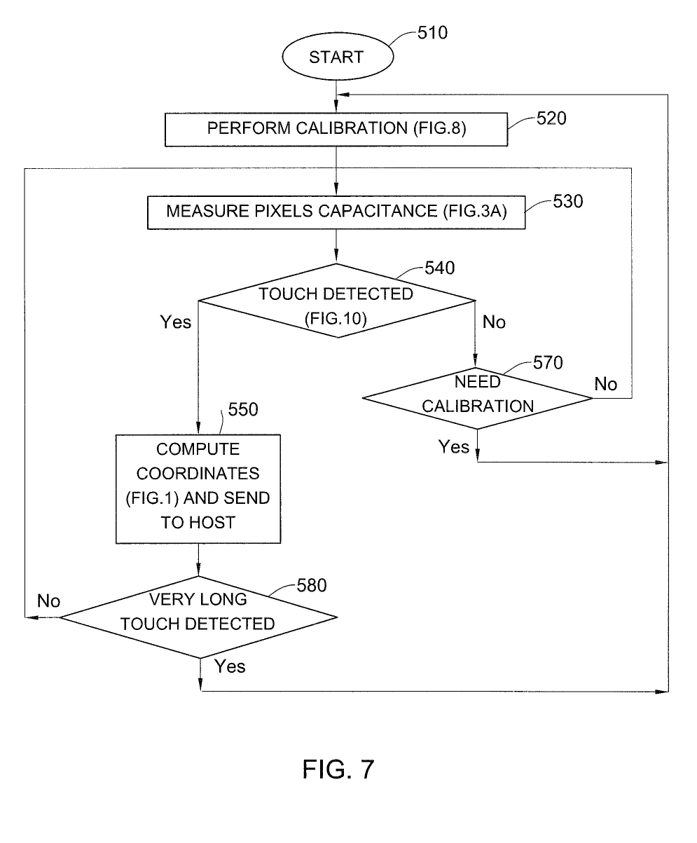

FIG. 3A is a simplified schematic illustration of one of the 6 sense circuits 124 in FIG. 1A in which, in contrast to an alternative embodiment shown in FIG. 3B, pixel data (a pixel's transparency state) is not used for correction of capacitance sensing. It is appreciated that the apparatus of FIG. 3A illustrates only one possible implementation of a capacitance sense (measurement) circuit of a single column. In FIG. 3A, the LCD is scanned in rows so for each scanned row there is one baseline register 230 filled during calibration e.g. as described below with reference to FIG. 8, and one measurement register 220. Upon successful calibration, the content of the measurement registers 220, also termed herein “Registers”, are copied to the baseline registers 230, whose contents are termed herein the “Baselines”. According to certain embodiments of the present invention, the host reads the value of the most recent measurements minus their baselines, thereby to detect only changes. The illustrated embodiment includes hardware apparatus performing functions such as but not limited to storage of calibration values and computation of change as above, however alternatively, the same functionalities may be implemented in software, where a computer or other logic executes the computations.

If the above circuit is repeated per each column, a total of N_{ROWS}*M_{COLUMNS} registers is accessed by the host to read the touch data of the entire touch screen. In some embodiments, the value of the register-baseline 230 is compared with a known threshold and a status bit per register is set or cleared based on the threshold. According to this embodiment, it is sufficient to read just that bit in order to determine whether or not a touch was detected at some point.

FIG. 3B is a simplified schematic diagram of the source driver of FIG. 1A according to a second embodiment of the present invention in which a sub-pixel has a current known transparency state, the source driver comprising a capacitance modifier operative to modify a capacitance value generated by the capacitance sensing circuitry based at least partly on the capacitance sensing circuitry.

In certain applications, the illumination/transparency state of the LCD pixel may also affect the electrode capacitance. The pixel state information, available as part of the frame buffer information can be used to compensate for the electrode capacitance during the processing stage. The capacitance measurement method shown herein can be used with any TFT or TFT-like active matrix array e.g. in LCDs, OLED, and electro-phoretic displays. A particular feature of the embodiment of FIG. 3B is that pixel information is used to correct measured values of capacitance. Pixel data is recorded in the pixel value registers 260, typically during the screen update process, and fed to a lookup table 270 which associates pixel values with estimated change of capacitance due to pixel state (illumination/transparency). This associated estimate capacitance change is subtracted from the measured capacitance. The look-up table is loaded in a set-up stage in which suitable experiments are performed for a particular application to determine how the capacitance changes as a function of pixel state, in the application in question.

The apparatus of FIGS. 3A and 3B is also suitable for applications where the touch resolution is lower than the actual screen resolution (by grouping rows and columns). In such a case, “M” above would be lower than the screen resolution.

FIG. 4 is a simplified schematic illustration of sense unit 340 in FIGS. 3A and 3B.

FIG. 5A is a simplified schematic illustration of one of the 6 drive circuits 122 in simplified FIG. 1A, according to a first embodiment of the present invention which does not use the screen's pixel inversion period for capacitance measurement.

FIG. 5B is a simplified schematic illustration of one of the 6 drive circuits 122 in simplified FIG. 1A, according to a second embodiment of the present invention which uses the screen's pixel inversion period for capacitance measurement. A particular advantage of using the pixel inversion period to measure capacitance as per certain embodiments of the present invention is that no additional phase of measurement need be provided.

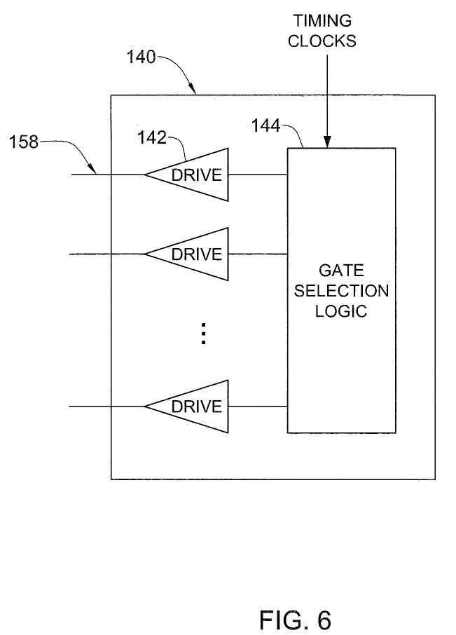

FIG. 6 is a simplified schematic diagram of the gate driver 140 of FIG. 1A.

FIG. 7 is a simplified flowchart illustration of a method for using the system of FIG. 1A. Calibration is typically repeated from time to time e.g. every predetermined interval to compensate for changes in the baseline capacitance due to changes in the environmental conditions (step 570). Such intervals can range from a few seconds to a few minutes.

FIG. 8 is a simplified flowchart illustration of a method for performing the calibration step 520 of FIG. 7. Margins used in step 640 depend on the qualities of the LCD glass and reflect artifactual changes, relative to the application, and changes to capacitance due to changes in environmental conditions such as but not limited to humidity, temperature, light, and ambient pressure. These parameters affect the baseline capacitance of the LCD, hence are assumed by the system to vary only within predefined margins, guaranteed by the maker of the LCD. Variations beyond the predefined margins used in step 640 are assumed to be caused by a finger's touch and thus care should be taken not to use such measurement results as a basis for calibration.

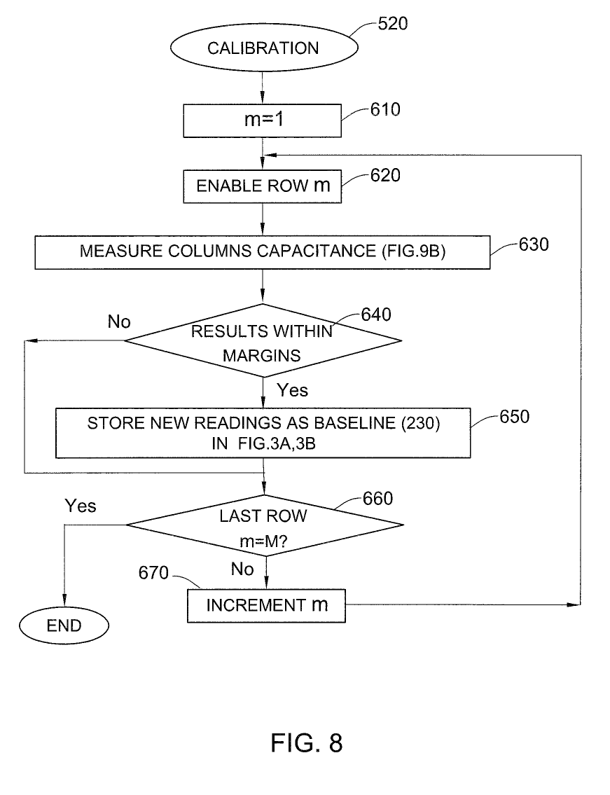

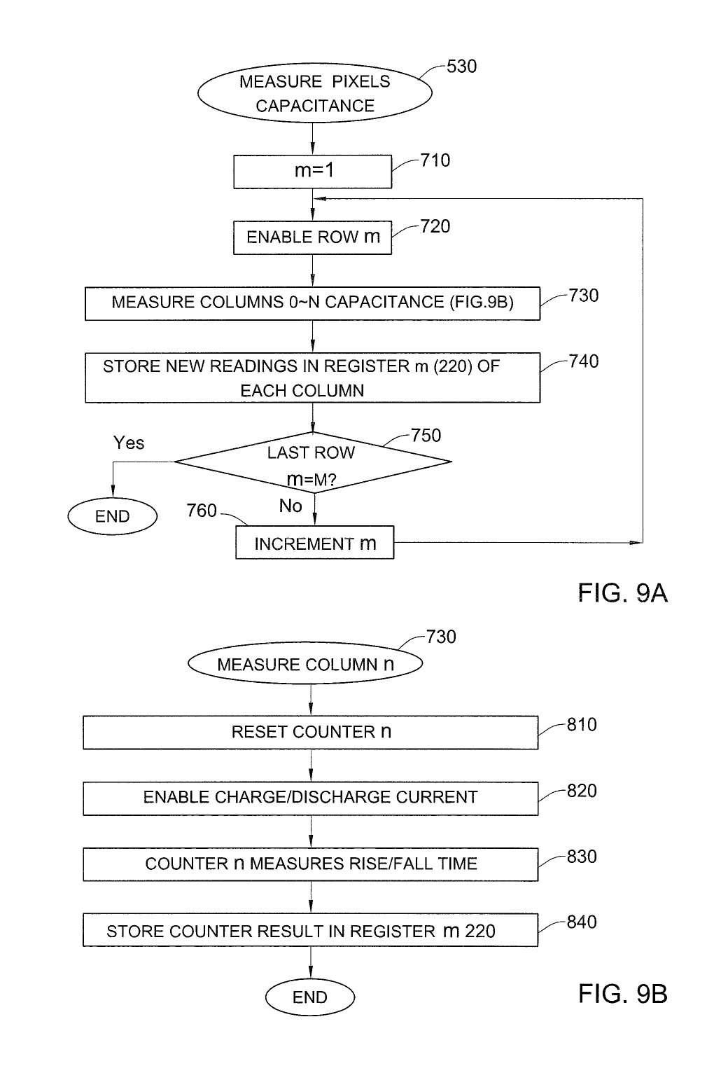

FIG. 9A is a simplified flowchart illustration of a method for performing the pixel capacitance measuring step 530 in FIG. 7.

FIG. 9B is a simplified flowchart illustration of a method for performing the column capacitance measuring step 730 in FIG. 9A.

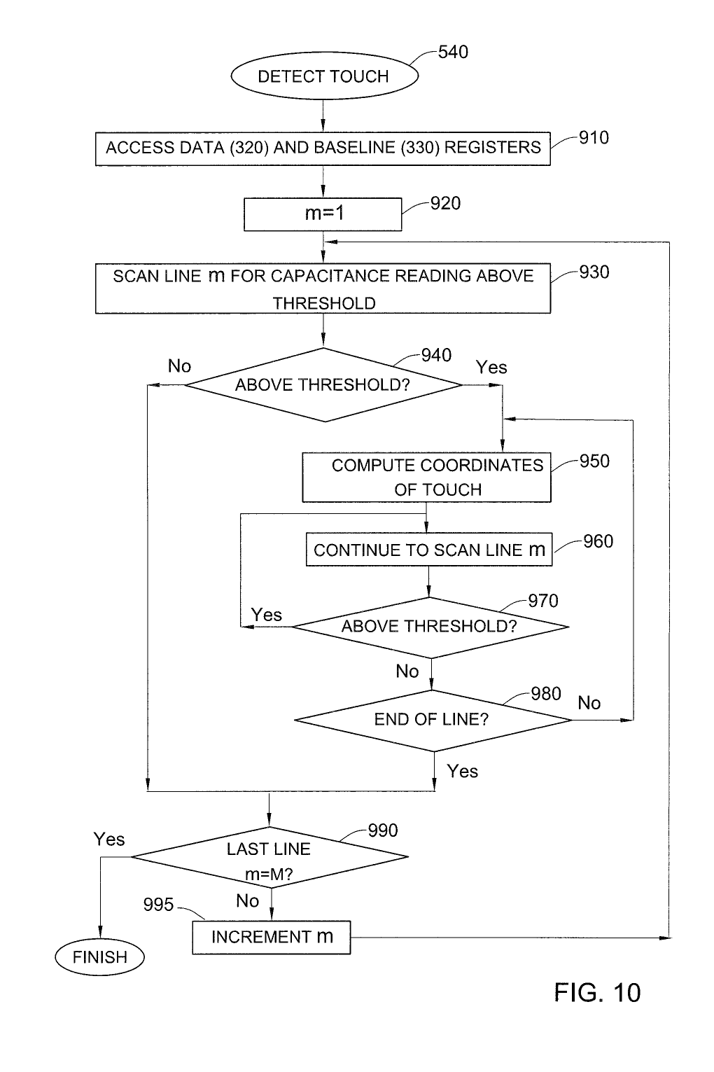

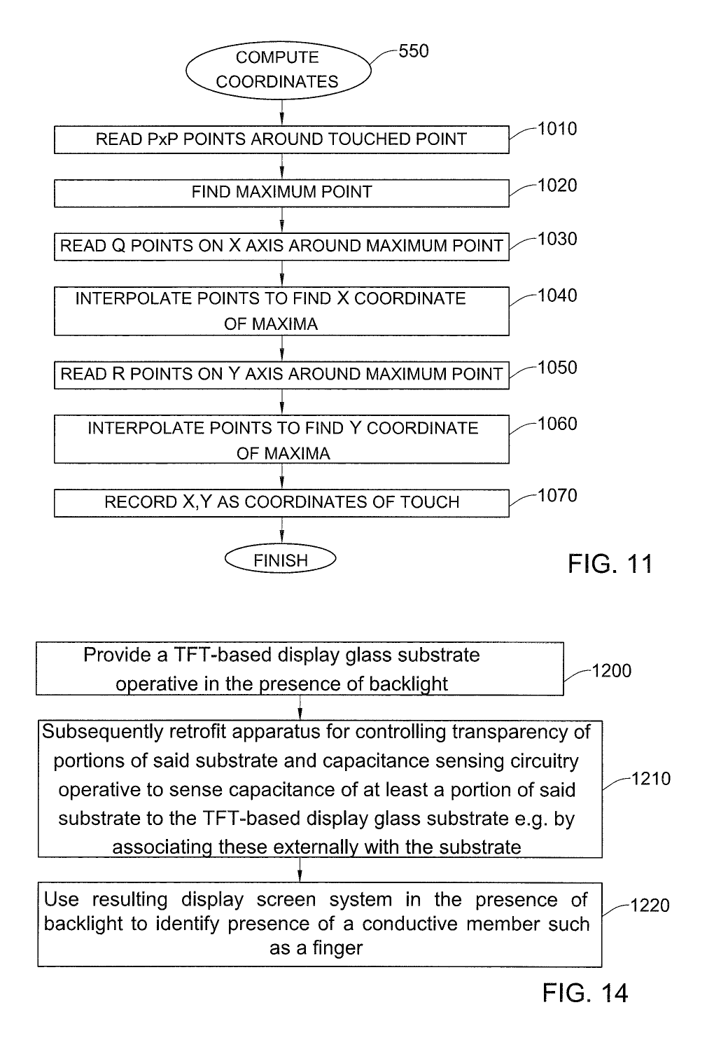

FIG. 10 is a simplified flowchart illustration of a method for performing the touch detection step 540 of FIG. 7. In FIG. 10 the “touch data” comprises a matrix of capacitance values measured. The matrix is scanned, line by line, and each line is scanned column by column. When a point with a reading above a predefined threshold is detected (step 940), the method of FIG. 11 is used. The threshold is configured by the LCD panel maker or the panel user according to the performance required in a specific application; lower thresholds mean more sensitivity at the cost of more false alerts and conversely, higher thresholds mean less sensitivity but less false alerts.

FIG. 11 is a simplified flowchart illustration of a method for performing the touch coordinate computation step 950 of FIG. 7. The method of FIG. 11 finds the coordinates of a finger's touch. When a point in a line is detected above the threshold, a matrix of P×P points around that point is read. The maximum reading within this matrix is searched for. When that maximum reading is found, a vector on P readings in the X-axis (lines) around that point is read and then a polynomial (or other) curve is fitted to the vector. When the curve is fitted, the coordinate of the curve maxima is computed. That point usually lies between two points on the touch screen. The same process is repeated for the Y axis using Q points (to differentiate X and Y axes). Now the coordinates of the touch are recorded.

P and Q should be selected, relative to the touch screen resolution, such that the area covered by them is slightly larger that that of a finger touch so the method of FIG. 11 covers the entire area of the finger touch. Once a finger touch is recorded in the P×Q matrix, no further computations are done in that area (for consecutive lines being scanned).

FIG. 12A is a simplified time-line showing a suitable timing for the operation of the method of FIG. 7 vs. the refresh operation of the apparatus of FIG. 1A for the embodiment of FIG. 5A. The time-line of FIG. 12A interleaves the measurement and the display functions in the time domain such that many, most or all measurements are performed at times when the LCD display is not being refreshed. Typical refresh cycles of displays include various “dead times” in which new data is not supplied to the display. Such times are known as horizontal and vertical sync and may account to up to 30% of the display cycle time. During such time, capacitance measurement can be performed for some or all lines. When a measurement is complete (after one or several display cycles) the data may be sent to the host. Partial data may also be sent after part of the screen has been scanned and measured.

FIG. 12B is a simplified time-line showing a suitable timing for the operation of the method of FIG. 7 vs. the refresh operation of the apparatus of FIG. 1A for the embodiment of FIG. 5B. Optionally, as shown in FIG. 12A, a special measurement phase is allocated that is temporally separate from the regular scan. The other method would take advantage of the scan. Alternatively however, as shown in FIG. 12B, the “pixel inversion period” may be used to measure capacitance. Each pixel is typically driven by a voltage that reverses polarity every few milliseconds in order for the pixel to have constant color and power. The method of driving alternate polarity voltage is called inversion. The time required to reverse the polarity of the voltage is proportional to the voltage and to the total capacitance of the pixel element. By measuring this time, while taking into account the magnitude of voltage change and the current used, the capacitance of the pixel can be estimated. This method allows for subtle changes of capacitance to be recorded and later processed e.g. as shown in FIG. 10, to detect touch.

When pixel inversion is used to measure capacitance as in FIG. 12B, the measurements are actually part of the regular display operation sequence and do not require special timing as in FIG. 12A. This may allow the display data rate to be reduced by the 30% overhead described above with reference to the embodiment of FIG. 12A.

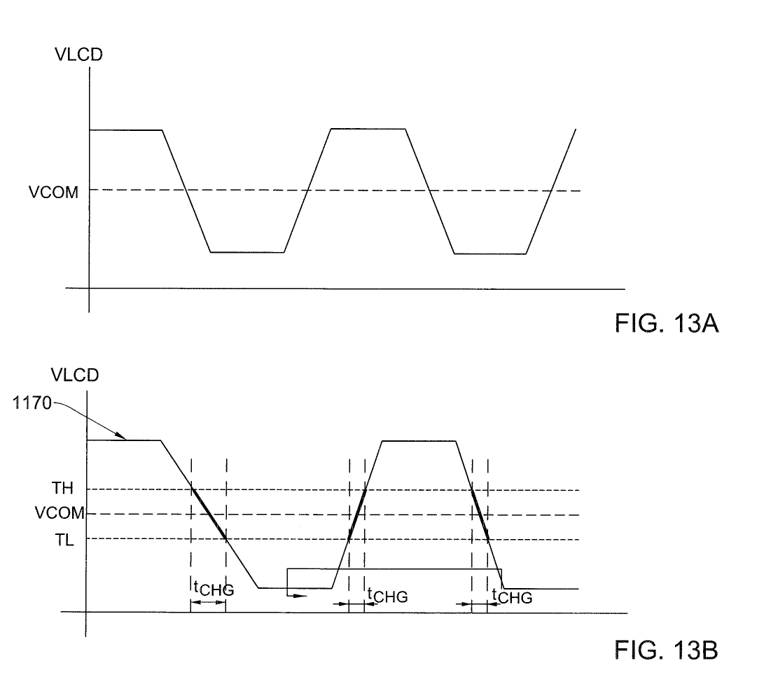

FIG. 13A is a prior art, voltage vs. time graph showing a Pixel Inversion process. By performing inversion with a known, fixed current, the slope of the voltage change becomes a function of the pixel capacitance. Evaluating the slope is done by measuring the rise/fall times between fixed voltage levels (TH, TL) as shown in FIG. 13B which is a graph of pixel inversion with rise/fall time measurement. Applying pressure to the screen also changes the capacitance parameters of the pixels under mechanical stress. This change of capacitance can also be recorded and processed for touch detection. FIG. 13B is a graph showing pixel inversion with rise/fall time measurement, useful in understanding the operation of the embodiment of FIGS. 5B and 12B. During pixel inversion the voltage on the cell is inverted. The measurement scheme of FIGS. 5B and 12B takes advantage of the voltage inversion to measure the time it takes to change the voltage while it is done by a known, constant current. Depending on the direction of inversion, current is either sourced to or sinked from the source line. The pixel inversion control logic determines the current flow direction. Pixel inversion control is known in the art of LCD display manufacturing methods.

FIG. 14 is a simplified flowchart illustration of a method for providing a display screen system operative to identify presence of a conductive member. The method of FIG. 14 typically includes some or all of the following steps, suitably ordered e.g. as shown:

Step 1200: Provide a TFT-based display glass substrate operative in the presence of backlight, e.g. a TFT-LCD screen which may include at least one gate driver

Step 1210: subsequently retrofit apparatus for controlling transparency of portions of the substrate and capacitance sensing circuitry operative to sense capacitance of at least a portion of the substrate to the TFT-based display glass substrate e.g. by associating a source driver including the circuitry and optionally the apparatus and/or a gate driver optionally including the apparatus, externally with the substrate

Step 1220: use resulting display screen system in the presence of backlight to identify presence of a conductive member such as a finger including temporally controlling the apparatus for controlling transparency

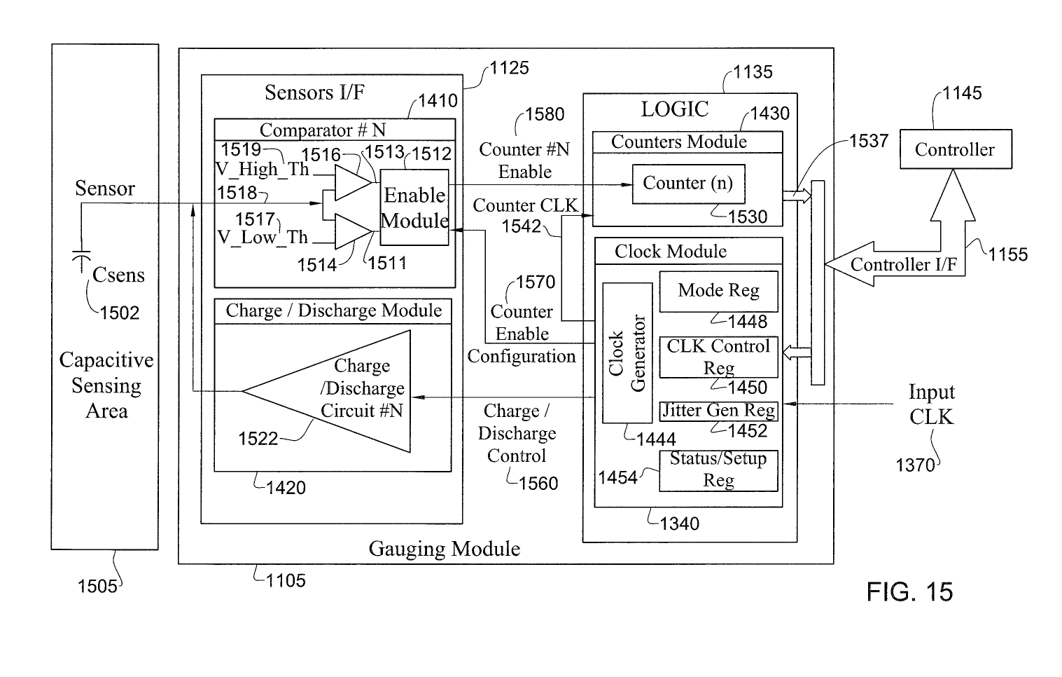

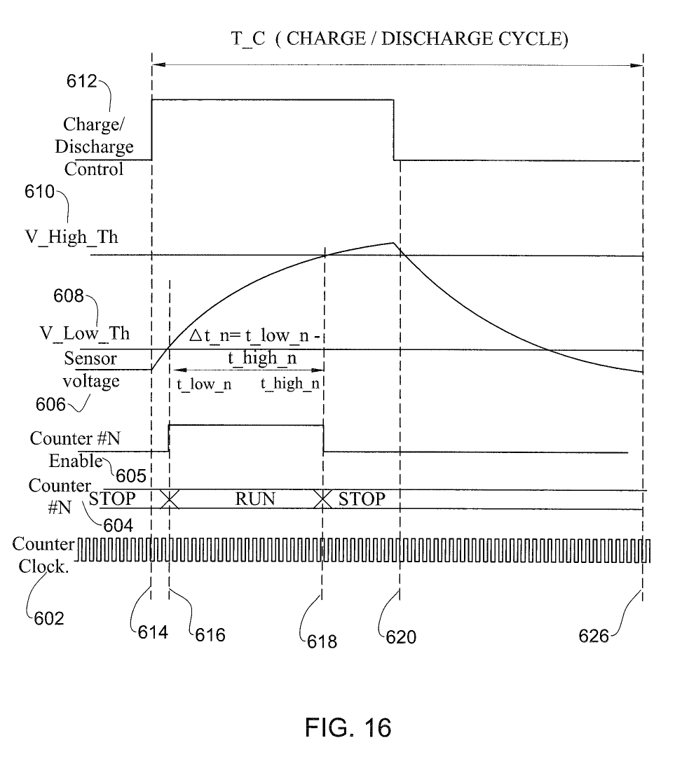

Any suitable methods and systems may be employed in using the counter and analog front end 240 of FIGS. 3A-3B, also termed herein “sense unit 240” and particularly capacitance measurement logic 340 of FIG. 4 to measure small changes in capacitance resulting e.g. from proximity of a finger to the LCD screen, and in performing steps 520, 530 and 550 of the touch detection method of FIG. 7. Examples of suitable methods and systems for this purpose are described in co-pending published U.S. Patent Application No. 20090046827 (U.S. Ser. No. 11/889,435), filed Aug. 13, 2007, published Feb. 19, 2009 and entitled “Time interval measurement for capacitive detection”. Certain teachings of this publication are now described with reference to FIGS. 15 and 16 which are substantially the same as FIGS. 5-6 of the above-referenced publication.

It is noted that a time interval may be a function of the capacitance of a capacitive sensor, and therefore measurement of a time interval, for example the measured time interval 337 associated with the sensor, may in some cases substitute for measuring capacitance of the sensor. A brief explanation of the relationship between capacitance and time is therefore now provided.

As is well known in the art, the current i through a capacitor is given by:

$$i = C ( \frac{d v}{d t} )$$

where C is the capacitance of the capacitor and

$$\frac{d v}{d t}$$

is the change of voltage over time across the capacitor.

Rearranging the equation results in:

$$\frac{d t}{d V} = \frac{C}{i}$$

The rearranged equation states that the reciprocal of the rate of change (derivative) of the voltage across a capacitor, i.e. the time interval during which the voltage across the capacitor changes, is equal to the capacitance of the capacitor divided by the current through the capacitor. The time interval during which the voltage across the capacitor changes is a monotonic function of the capacitance of the capacitor because the time interval is larger for a larger capacitance than for a smaller capacitance. For example, in cases where more than one time interval during which the voltage changes across the capacitor are measured cumulatively, the measurement representing more than one interval may be considered a monotonic function of the capacitance of the capacitor because the measurement is a monotonic function of the average capacitance of the capacitor, being larger for a larger average capacitance than for a smaller average capacitance.

FIG. 15 illustrates a block diagram of a detailed capacitive detection system relevant for one capacitive sensor 1502 from capacitive sensing area 1505, according to an embodiment of the present invention. Capacitive sensor 1502 is represented by a capacitor (using the capacitor symbol) for simplicity of illustration. Assuming an embodiment with X and Y sensors, sensor 1502 may be either an X or Y sensor. For simplicity of illustration the embodiment shown in FIG. 15 assumes that each capacitive sensor in capacitive sensing area module 1505 is associated with a separate comparator module 1410, counters module 1430, and charge/discharge module 1420, or that a plurality of capacitive sensors is associated with the same 1410, 1430, and/or 1420 but that each of the associated sensors operates with respect to the shared 1410, 1430, and/or 1420 at a separate time. For simplicity of illustration, the embodiment in FIG. 15 also assumes that all sensors in capacitive sensing area 1505 are associated with the same clock module clock generator 1444, and registers 1448, 1450, 1452, and 1454. For ease of understanding a numerical labels of a signal relating to sensor 1502 is distinguished in the description from signals relating to all sensors in capacitive sensing area 1505 by beginning with “5” for example counter clock 1542, charge/discharge control 1560, counter enable configuration 1570, counter enable 1580, however depending on the embodiment a signal associated with sensor 1502 may or may not be distinct from signals relating to other sensors.

In the illustrated embodiment of FIG. 15, charge/discharge module 1420 associated with capacitive sensor 1502 includes charge/discharge circuit 1522. In the illustrated embodiment comparator module 1410 associated with capacitive sensor 1502 includes first comparator 1514 and second comparator 1516 and enable module 1512. In the illustrated embodiment counter module 1430 associated with capacitive sensor 1502 includes counter 1530.

In the embodiment illustrated in FIG. 15, when charge/discharge control signal 1560 emitted by clock module 1340 indicates that capacitive sensor 1502 should charge, charge/discharge circuit 1522 causes capacitive sensor 1502 to charge. When charge/discharge control signal 1560 indicates that sensor 1502 should discharge, charge/discharge circuit 1522 causes sensor 1502 to discharge. The voltage 1518 across capacitive sensor 1502 is provided to first comparator 1514 and second comparator 1516.

The elements comprised in charge/discharge circuit 1522 may vary depending on the embodiment and are not limited to any particular configuration. In one embodiment, charge/discharge circuit 1522 includes a current source connected to a positive voltage supply (Vcc), a first switch in series with the current source and a second switch in parallel to capacitive sensor 1502. In this embodiment, when charge/discharge control signal 1560 indicates charging, the first switch closes and the second switch opens, causing the capacitive sensor to be charged by the constant current provided from the current source. Similarly, in this embodiment, when charge/discharge control signal 1560 indicates discharging, the first switch opens and the second switch closes, allowing capacitive sensor 1502 to discharge through the second switch to ground. The reader will understand that in other embodiments charge/discharge circuit 1522 may comprise elements in a different configuration which will provide charging and discharging functionality.

Charge/discharge control signal 1560 and charge/discharge circuit 1522 are illustrated in the embodiment of FIG. 15 as affecting the charging and discharging of capacitive sensor 1502. In another embodiment, there may be separate functionality for affecting the charging of capacitive sensor 1502 and for affecting the discharging of capacitive sensor 1502.

Continuing with the description of the embodiment of FIG. 15, first comparator 1514 compares sensor voltage 1518 with a low voltage (reference) level 1517, and generates an output 1511 which varies depending on whether sensor voltage 518 is higher or lower than low voltage level 1517. Second comparator 1516 compares sensor voltage 1518 with a high voltage (reference) level 1519, and generates an output 1513 which varies depending on whether sensor voltage 1518 is higher or lower than high voltage level 1519. In another embodiment, the functionality of comparators 1514 and 1516 may be combined in a single comparing element.

The terms low and high, when referring to voltage levels 1517 and 1519, should be understood as relative to one another, and therefore high voltage level 1519 is larger than low voltage level 1517. The values of low voltage level 1517 and high voltage level 1519 are not limited by the invention. Voltage values 1517 and 1519 are constant in some cases over time, and in other cases voltage values 1517 and 1519 may vary over time. Voltage values 1517 and 1519 are both non-zero in one embodiment.

In some cases, there may be an advantage to an embodiment where the values of both low voltage level 1517 and high voltage level 1519 are non-zero. In some of these cases, the usage of a zero value may be less stable from noise than using non-zero values. In some of these cases, alternatively or additionally the value zero may be in the non-linear range of the charging/discharging curve of capacitor 1502 and therefore less stable.

Referring again to the embodiment illustrated in FIG. 15, output 1511 from first comparator 1514, output 1513 from second comparator 1516, and a counter enable configuration signal 1570 are provided to an enable module 1512. Enable module 1512 outputs a counter enable signal 1580 causing a counter 1530 associated with sensor 1502 to run or not run. In some embodiments, counter 1530 is thereby configured to run during the time interval that voltage 1518 across sensor 1502 ranges between the low voltage level 1517 and the high voltage level 1519 (where the voltage 1518 may be increasing and/or decreasing). In one of these embodiments, counter 1530 is configured to run during the time interval in which voltage 1518 across sensor 1502 (when charging) increases from low voltage level 1517 to high voltage level 1519. In another of these embodiments, counter 1530 is alternatively or additionally configured to run during the time interval in which voltage 1518 across sensor 1502 (when discharging) decreases from high voltage level 1519 to low voltage level 1517. In one embodiment, counter enable configuration signal 1570 controls whether counter 1530 runs when voltage 1518 ranges between the low voltage level 1517 and the high voltage level 1519 during the charging, during the discharging, or during both the charging and discharging of sensor 1502. In the discussion herein, it should be understood that depending on the embodiment, the range between low voltage value 1517 and high voltage value 1519 when counter 1530 runs, may or may not include low voltage value 1517 and/or high voltage value 1519.

As illustrated in the embodiment of FIG. 15, enable module 512 is external to counter 1530 but in another embodiment, enable module 1512 may be incorporated into counter 1530.

As shown in the embodiment of FIG. 15, a counter clock 1542 is provided to counter 1530. Therefore when counter 1530 is running, counter 1530 counts the cycles of counter clock 1542. The time interval during which the voltage across capacitive sensor 1502 ranges between low voltage level 1517 and high voltage level 1519 is therefore measured by counter 1530 in “units” or “counts” of counter clock cycles in the illustrated embodiment (i.e. counter 1530 counts the number of counter clock cycles during which counter enable signal 1580 is at the “enable” level). In other embodiments, the time interval may be measured in different units than cycles of counter clock 1542. For example, in one of these embodiments, counter 1542 may instead be an element which measures the time period in units based on seconds (for example, nanoseconds, microseconds, etc).

In order to facilitate reader understanding, the functionality of sensor interface 1125 associated with sensor 1502 and counter module 1430 associated with sensor 1502 was divided into the elements shown in FIG. 15 in accordance with one embodiment, but the division should not be considered binding. In some embodiments the functionality may be divided into fewer, more and/or different elements than illustrated in FIG. 15. In some embodiments, the functionality may be divided differently into the elements illustrated in FIG. 15. In some embodiments any element in FIG. 15 may have more, less and/or different functionality than described herein.

FIG. 6 is a timing diagram related to the operation of counter 1530 while sensor 1502 is charging, according to certain embodiments of the present invention. As shown in the embodiment of FIG. 16, a timing diagram 1602 illustrates counter clock signal 1542 over time. A timing diagram 1604 illustrates when counter 1530 runs and when counter 1530 is not running (stops) over time. A timing diagram 1605 illustrates counter enable signal 1580 over time, where in the illustrated embodiment counter enable signal 1580 is high for enabling and low for disabling. A timing diagram 1606 illustrates the voltage 1518 across capacitive sensor 1502 over time. Timing diagrams 1608 and 1610 respectively illustrate low voltage level 1517 and high voltage level 1519 over time. A timing diagram 1612 illustrates the charge/discharge control signal 1560 over time, where in the illustrated timing diagram charge/discharge control signal 1560 is high for charging and low for discharging.

In the embodiment illustrated in FIG. 16 at time 1614, charge/discharge control signal 1560 changes to a “charge” level as shown in timing diagram 1612 and capacitive sensor 1502 begins charging. As capacitive sensor 1502 charges, the voltage 1518 across capacitive sensor 1502 increases over time, as illustrated by timing diagram 1606. At time point 1616, (t_low_n), the voltage 1518 across capacitive sensor 1502 reaches low voltage level 1517 (illustrated by the crossover of timing diagram 1606 and timing diagram 1608). Therefore at time point 1616, counter enable signal 1580 changes to an “enable” level (see timing diagram 1605) and counter 1530 begins running as illustrated by timing diagram 1604. In one embodiment, time point 1616 is the time point when low voltage level 1517 is reached, whereas in another embodiment time point 1616 is the time point when low voltage level 1517 is exceeded. At time point 1618, (t_high_n), the voltage 1518 across capacitive sensor 1502 reaches high voltage level 1519 (illustrated by the crossover of timing diagram 1606 and timing diagram 1610). Therefore at time point 1618 counter enable signal 1580 changes to a “disable” level (see timing diagram 1605) and counter 1530 stops running as shown in timing diagram 1604. In one embodiment, time point 1618 is the time point when high voltage level 1519 is reached, whereas in another embodiment time point 1618 is the time point when high voltage level 1519 is exceeded. The time Δt_n represents the difference in time between time point 1616 (t_low_n) and time point 1618 (t_high_n), i.e., a time interval during which counter 1530 runs. At time point 1620, charge/discharge control signal 1560 changes to a “discharge” level as shown in timing diagram 1612 and the capacitive sensor begins discharging. In one embodiment, during the discharging, counter 1530 continues to be disabled (i.e. does not run). In another embodiment during the discharging, counter 1530 runs when sensor voltage 1518 ranges between low voltage level 1517 and high voltage level 1519. At time point 1626, charge/discharge signal 1520 completes one charge/discharge cycle, and therefore the illustrated charge/discharge period T_c equals the time difference between time point 1614 and time point 1626. In one embodiment charge/discharge cycle 1520 then repeats e.g. with charge/discharge control 1520 changing to the “charge” level at time point 1626 as at time point 1614.

According to certain embodiments of the present invention, the capacitance sensing circuitry of FIG. 1A is operative only in specific periods of time in which the transparency states of the conductive areas are constant; FIG. 12A, for example, is a timeline for capacitance measurement effected while the LCD screen is idle. Further according to certain embodiments, the planar element of FIG. 1A has a first, relatively high resolution defined by its independently addressable areas and used for display. But during these specific periods of time, sets of source drivers, via which the subpixels are addressable, are shorted together and sets of gate drivers, via which the subpixels are addressable, are shorted together, thereby to generate a second, lower resolution, used for sensing capacitance during the specific periods of time. This is particularly useful in applications in which pixels are small relative to the size of the conductive element to be sensed, such as a finger.

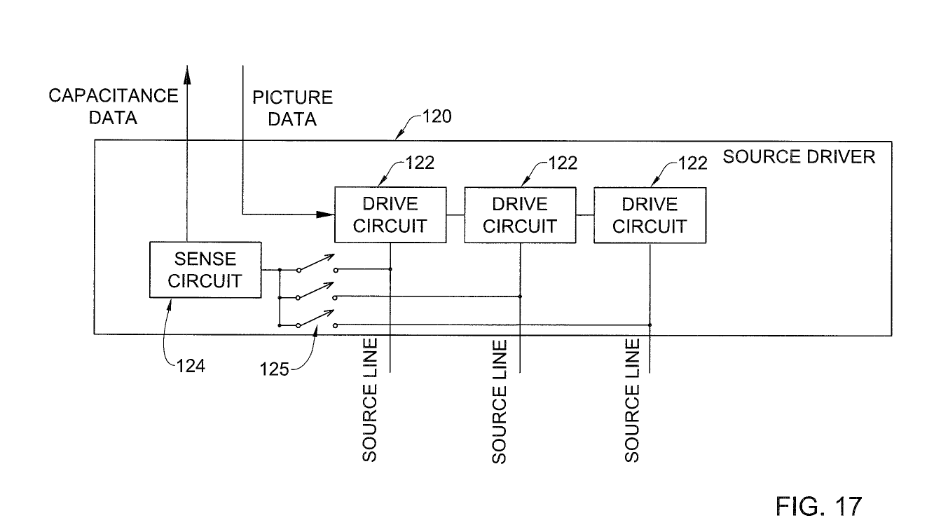

FIG. 17 illustrates a modification to source driver 120 of FIG. 1A which reduces the number of sense circuits 124 by a factor of k and adds k switches 125 per sense circuit. When capacitance measurement is performed, all k switches 125 may be closed, shorting the k source lines together for the duration of the capacitance measurement. The gate driver 140 drives j gates high for the period of the measurement. Gate selection logic 144 is responsible for driving the “J” gates high at the same time. Using the apparatus of FIG. 17, the resolution of the touch sensor (“second resolution”) becomes lower by a factor of k in the X-axis and by a factor of j in the Y-axis, relative to the display resolution (“first resolution”). An example of a suitable value for j and k may be j=k=20, although for simplicity, the parameters do not take this value in the illustrated embodiment.

It is appreciated that software components of the present invention including programs and data may, if desired, be implemented in ROM (read only memory) form including CD-ROMs, EPROMs and EEPROMs, or may be stored in any other suitable computer-readable medium such as but not limited to disks of various kinds, cards of various kinds and RAMs. Components described herein as software may, alternatively, be implemented wholly or partly in hardware, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software.

Features of the present invention which are described in the context of separate embodiments may also be provided in combination in a single embodiment. Conversely, features of the invention, including method steps, which are described for brevity in the context of a single embodiment or in a certain order may be provided separately or in any suitable subcombination or in a different order. “e.g.” is used herein in the sense of a specific example which is not intended to be limiting. Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, PDA, Blackberry GPRS, Satellite including GPS, or other mobile delivery.

1. A display screen system operative to identify presence of a conductive member, the system comprising:
a structural, transparent planar element including an array of conductive areas independently electrically addressable by a source of electric power, each conductive area having a plurality of transparency states controlled by said source of electric power; and
capacitance sensing circuitry operative to sense capacitance of at least one of said conductive areas.

2. A system according to claim 1 wherein said plurality of transparency states includes a plurality of states differing in their degree of transparency to light of at least one wavelength.

3. A system according to claim 1 wherein at least one of said areas comprises a sub-pixel.

4. A system according to claim 1 wherein said capacitance sensing circuitry is operative to separately sense capacitance in each of said conductive areas.

5. A system according to claim 1 and also comprising a conductive member identifier operative to analyze capacitance sensed by said circuitry in an individual conductive area and to generate a binary output indicating presence or absence of a conductive member adjacent said individual conductive area.

6. A method for providing a display screen system operative to identify presence of a conductive member such as a finger, the method comprising:
providing a TFT-based display glass substrate including source lines; and
providing apparatus for controlling transparency of portions of said substrate and capacitance sensing circuitry operative to sense capacitance of at least a portion of said substrate, including using said source lines for sensing capacitance.

7. A method according to claim 6 and also comprising using timing controller apparatus to temporally control said apparatus for controlling transparency.

8. A method according to claim 6 wherein said substrate comprises a TFT-LCD glass substrate.

9. A method according to claim 6 and also comprising providing a source driver including said apparatus for controlling transparency.

10. A method according to claim 9 wherein said source driver also includes said capacitance sensing circuitry.

11. A method according to claim 6 and also comprising providing a gate driver including said apparatus for controlling transparency.

12. A method according to claim 6 wherein said glass substrate includes at least one gate driver.

13. A method for using a display screen system operative to identify presence of a conductive member, the method comprising:
providing a structural, transparent planar element including an array of conductive areas independently electrically addressable by a source of electric power, each conductive area having a plurality of transparency states controlled by said source of electric power; and capacitance sensing circuitry operative to sense capacitance of at least one of said conductive areas,
wherein each said structural, planar conductive area comprises a pixel having a pixel inversion period,
and wherein said capacitance sensing circuitry is operative, during the pixel inversion period, to identify presence of a conductive member.

14. A method according to claim 13 and wherein said capacitance sensing circuitry is operative only during the pixel inversion period.

15. A system according to claim 1 wherein said capacitance sensing circuitry is operative only in periods of time in which the transparency states of the conductive areas are constant.

16. A system according to claim 15 wherein said planar element has a first resolution defined by said areas independently addressable and wherein said conductive areas are addressable via source drivers and gate drivers and wherein, during said periods of time, sets of source drivers are shorted together and sets of gate drivers are shorted together, thereby to generate a second resolution, used for sensing capacitance during said periods of time, wherein said second resolution is lower than said first resolution which is used for display.

17. A system according to claim 3 wherein said sub-pixel has a current known transparency state and also comprising a capacitance modifier operative to modify a capacitance value generated by said capacitance sensing circuitry based at least partly on said transparency state.

18. A system according to claim 1 wherein said conductive area includes an ITO layer.

19. A method according to claim 13 and also comprising using said planar element as a refreshable display by interleaving capacitance sensing by said capacitance sensing circuitry with refreshing of at least some of said array of conductive areas.

20. A system according to claim 1 wherein said display screen comprises a TFT-based display screen.

21. A system according to claim 20 wherein said TFT-based display screen comprises an LCD screen.

22. A method according to claim 13 and wherein said capacitance sensing circuitry is operative to identify presence of a finger.

23. A method according to claim 6 wherein said substrate includes sub-pixels each including only one TFT switch and wherein said providing includes using a single TFT switch included in an individual sub-pixel for sensing a conductive element touching the individual sub-pixel.

24. A method according to claim 6 wherein said substrate includes pixels and said providing includes using said pixels as touch sensors.

25. A method according to claim 6 wherein said providing comprises retrofitting said controlling transparency of portions of said substrate and said capacitance sensing circuitry to said TFT-based display glass substrate, externally thereto.
